(19) United States
(12) Patent Application Publication
(10) Pub. No.: US 2023/0069412 A1
(43) Pub. Date: Mar. 2, 2023

(54) SWAY BLOCK ASSEMBLY FOR A THREE-POINT HITCH SYSTEM

(71) Applicant: CNH Industrial America LLC, New Holland, PA (US)

(72) Inventors: Chad Sietsema, Moorhead, MN (US); John T. Rasset, Barnesville, MN (US)

(73) Assignee: CNH Industrial America LLC, (omitted)

(21) Appl. No.: 17/462,994

(22) Filed: Aug. 31, 2021

(51) Int. Cl. A01B 59/041; B60D 1/30

(52) U.S. Cl. CPC A01B 59/041; B60D 1/30

(57) ABSTRACT

A sway block assembly includes a sway block having a wear surface and a flange. The flange includes a first slot configured to receive a first fastener to secure the sway block to a member of a three-point hitch system. The wear surface is configured to contact a wear block of the three-point hitch system. The wear surface is not formed on the flange.

### BACKGROUND

The present disclosure generally relates to a sway block assembly for a three-point hitch system.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A work vehicle (e.g., a tractor) may perform a number of operations during an agricultural process. For example, the work vehicle may haul harvested crops, transport equipment, etc. During an agricultural process, the work vehicle may couple to a towed implement. Work vehicles often couple to implements using a three-point hitch system. A three-point hitch system coupled to the work vehicle may attach to a towed implement via three elements. Additionally, the three-point hitch system may include actuator(s), joint(s), and mechanism(s) for operating component(s) of the towed implement.

The three-point hitch system may include sway blocks positioned to contact respective wear blocks. For example, the wear blocks may contact the sway blocks to substantially block sway of the hitch portion of the towed implement. Sway blocks are coupled to the three-point hitch system via one or more fasteners. Bolt heads of the fasteners may contact the surface of the sway blocks to fasten the sway blocks to the three-point hitch system. Unfortunately, bolt heads are often worn off after prolonged contact with the wear blocks, causing the sway blocks to fall off, and necessitating replacement. Additionally, residue (e.g., dust, dirt, etc.) may build up between the sway blocks and the three point-hitch structure.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In certain embodiments, a sway block assembly includes a sway block having a wear surface and a flange. The flange includes a first slot configured to receive a first fastener to secure the sway block to a member of a three-point hitch system. The wear surface is configured to contact a wear block of the three-point hitch system. The wear surface is not formed on the flange.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle coupled to an implement via a three-point hitch system, in accordance with an aspect of the present disclosure;

FIG. 2 is a perspective view of an embodiment of the three-point hitch system of FIG. 1, in accordance with an aspect of the present disclosure;

FIG. 3 is a rear view of the three-point hitch system of FIG. 2, in accordance with an aspect of the present disclosure;

FIG. 4 is a perspective view of an embodiment of a pair of sway blocks of the three-point hitch system of FIG. 2, in accordance with an aspect of the present disclosure;

FIG. 5 is a front perspective view of an upper sway block of the pair of sway blocks of FIG. 4, in accordance with an aspect of the present disclosure;

FIG. 6 is a rear perspective view of the upper sway block of FIG. 5, in accordance with an aspect of the present disclosure;

FIG. 7 is a front perspective view of a lower sway block of the pair of sway blocks of FIG. 4, in accordance with an aspect of the present disclosure;

FIG. 8 is a rear perspective view of the lower sway block of FIG. 7, in accordance with an aspect of the present disclosure;

FIG. 9 is a front perspective view of the pair of sway blocks of FIG. 4, in accordance with an aspect of the present disclosure;

FIG. 10 is a rear perspective view of the pair of sway blocks of FIG. 4, in accordance with an aspect of the present disclosure;

FIG. 11 is a perspective view of the pair of sway blocks of FIG. 4 contacting a wear block of the three-point hitch system, in accordance with an aspect of the present disclosure; and

FIG. 12 is an exploded view of another embodiment of sway blocks that may be employed within the three-point hitch system of FIG. 2, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Work vehicles (e.g., tractors) are used for a variety of tasks in agriculture. For example, work vehicles may be used for transporting harvested crops, tilling, spreading seed, etc. Often work vehicles utilize attachable towed implements to perform these tasks. Often, a towed implement (e.g., a tillage tool, a seeding tool, a planting tool, etc.) may couple to the work vehicle via a three-point hitch system of the work vehicle. The three-point hitch system may extend from the work vehicle and couple to the towed implement using three coupling elements. In addition to the coupling elements, the three-point hitch system has a frame, wear blocks, and sway blocks. The sway blocks and the wear blocks are configured to control the sway of the towed implement during operation of the work vehicle/towed implement. For example, the wear blocks and the sway blocks may be engaged with one another to substantially block sway. Unfortunately, fasteners coupling a sway block to a member of the three-point hitch system often wear before a wear surface of a sway block is fully diminished. As a result, sway blocks must be replaced more often. Furthermore, dust and debris often get caught between the sway blocks and the member, causing unwanted buildup. Additionally, coupling sway blocks to the three-point hitch system via fasteners and apertures may limit adjustability.

Accordingly, in certain embodiments disclosed herein, at least one sway block may have fastener opening(s) offset from the wear surface. As a result, the wear surface may wear without establishing contact between the fastener(s), which extend through the fastener opening(s) to couple the sway block to the member of the three-point hitch system, and the respective wear block. Additionally, at least one sway block may have a debris outlet passage configured to substantially reduce buildup of dirt and/or debris between the sway block and the member of the three-point hitch system. At least one sway block may also have slotted openings for receiving the fasteners. The slotted openings facilitate increased adjustability, thereby substantially reducing misalignment.

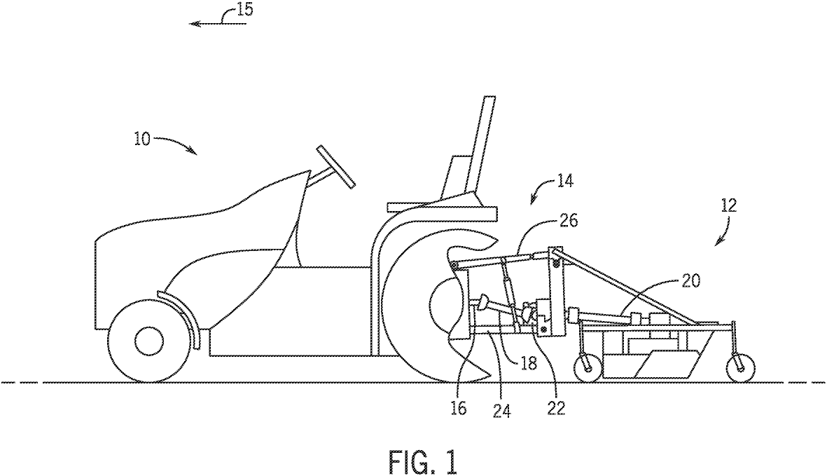

FIG. 1 is a side view of an embodiment of a work vehicle 10 coupled to an implement 12 (e.g., an agricultural implement) via a three-point hitch system 14. The work vehicle 10 is configured to tow the implement 12 (e.g., through a field) along a direction of travel 15. In the illustrated embodiment, the work vehicle 10 is a tractor. However, in other embodiments, the work vehicle may be any other suitable type of work vehicle configured to tow an implement, such as a harvester or a sprayer. Furthermore, in the illustrated embodiment, the implement 12 is a powered implement, such as a spreader, a rotary mower, or a rotary tiller. The implement is powered by a power-take off (PTO) shaft 16 of the work vehicle 10. An engine of the work vehicle 10 drives the PTO shaft to rotate (e.g., via a transmission, a PTO drive system, etc.), and rotation of the PTO shaft drives rotation of one or more rotary components of the implement 12, such as a rotary spreader system, mower blades, or a rotary tillage assembly. In the illustrated embodiment, the PTO shaft 16 includes a telescoping portion 18 configured to facilitate adjustment of a length of the PTO shaft 16 to accommodate different types of powered implements. However, in other embodiments, the work vehicle may have a non-telescoping PTO shaft. As illustrated, the PTO shaft 16 of the work vehicle 10 is coupled to a corresponding shaft 20 of the implement 12, and the corresponding shaft 20 of the implement 12 is configured to drive rotation of the rotary component(s) of the implement 12. The PTO shaft 16 and the corresponding shaft 20 of the implement 12 are coupled to one another via a connection assembly 22. The connection assembly 22 may include any suitable device(s) configured to couple the PTO shaft 16 to the corresponding shaft 20, such that rotation of the PTO shaft 16 drives the corresponding shaft 20 to rotate. While the implement 12 is a powered implement in the illustrated embodiment, in other embodiments, the implement may be a non-powered implement, such as a vertical tillage implement, a primary tillage implement, a seeding implement, or a finishing implement. In such embodiments, the PTO shaft of the work vehicle may not be coupled to a corresponding shaft of the implement, or the work vehicle may not include a PTO shaft.

In the illustrated embodiment, the implement 12 is coupled to the work vehicle 10 via the three-point hitch system 14 of the work vehicle 10. As discussed below, the three-point hitch system 14 includes two lower lift arms 24 and an upper link 26. The two lower lift arms 24 and the upper link 26 are coupled (e.g., rotatably coupled) to a chassis of the work vehicle 10. In certain embodiments, an actuator is coupled to the lower lift arms and configured to drive the lower lift arms to rotate relative to the chassis of the work vehicle. Each lower lift arm 24 includes an opening configured to receive a corresponding lower hitch pin of the implement 12, and the upper link 26 includes an opening configured to receive a corresponding upper hitch pin of the implement 12. In certain embodiments, each hitch pin of the implement 12 may be disposed within a corresponding opening to couple the implement 12 to the work vehicle 10. The three-point hitch system 14 may include a number of additional parts configured to control motion of the implement 12.

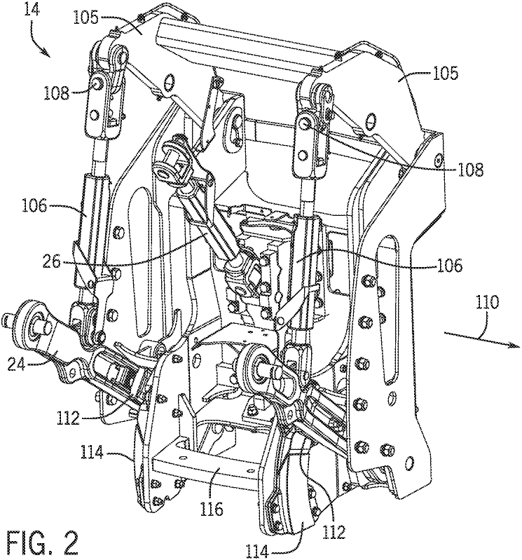

FIG. 2 is a perspective view of an embodiment of the three-point hitch system 14 of FIG. 1. As discussed above, the three-point hitch system includes the lower lift arms 24 and the upper link 26, which are configured to couple to the implement via hitch pins. The lower lift arms 24 may be raised and lowered by actuators (e.g., hydraulic cylinders, etc.). The actuators may couple to supports 105 and rotate the supports 105 with respect to the three-point hitch system 14. When rotated, the supports 105 raise or lower lift links 106, which in turn raise or lower the lift arms 24. In this way, the actuators may control vertical positions of the lower lift arms to adjust the height of the implement. The lift links 106 may be coupled to a frame of the three-point hitch system 14 via swivel joints 108, which enable the lower lift arms 24 to sway (i.e., move side-to-side) along a lateral axis 110. A wear block 112 extends from each lower lift arm 24. The wear blocks 112 are configured to contact sway blocks 114 to control (e.g., substantially reduce) the sway of the implement. The sway blocks 114 couple to a sway member 116 of the three-point hitch system.

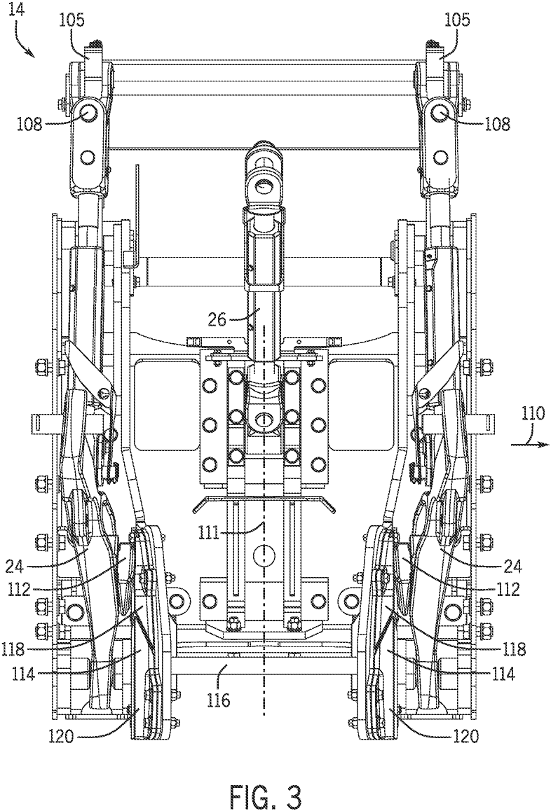

FIG. 3 is a rear view of a three-point hitch system 14 of FIG. 2. As shown, the wear blocks 112 extend inwardly from the lift arms 24 along the lateral axis 110. The wear blocks may contact an upper sway block 118 and a lower sway block 120 of the sway blocks 114. The three-point hitch system may also include additional upper sway block 118 and lower sway block 120 that are symmetrical to the sway blocks about a vertical axis 111 of the three-point hitch system 14. Each wear block 112 may be formed of metal via a casting process, a machining process, or some combination thereof. Additionally, the wear blocks 112 may be treated (e.g., via a heat treatment process, a work hardening process, etc.) to enhance certain mechanical properties. In certain embodiments, the lower sway block 120 may be removed. In a configuration with a removed lower sway block 120, allowable sway of the implement 12 may be adjusted by raising and lowering the lift arms 24 via the actuators and the lift links 106. In a lowered position, the wear blocks may not contact any block, or may contact the intermediary block 124, increasing sway. In a raised position, the wear blocks may contact the upper sway blocks 118, reducing sway.

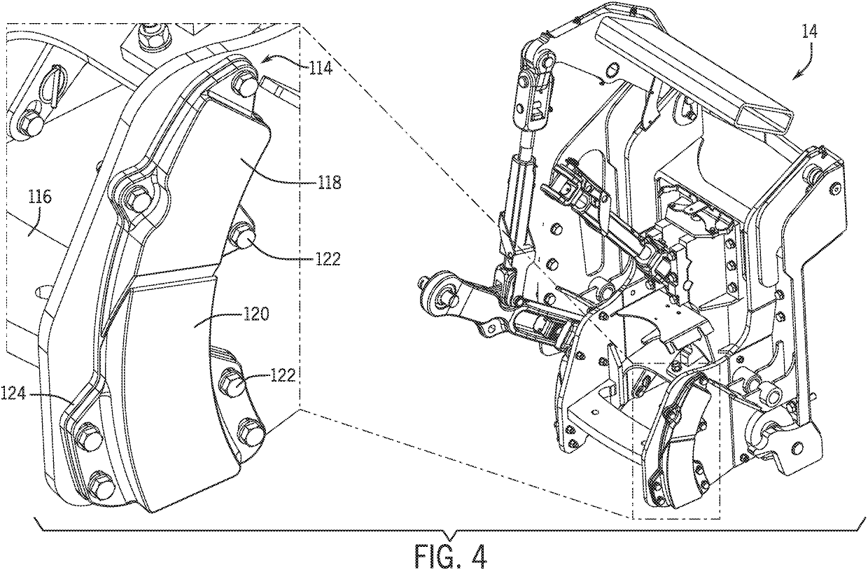

FIG. 4 is a perspective view of an embodiment of a pair of sway blocks 114 of the three-point hitch system 14 of FIG. 2. The sway blocks 114 may be formed of metal (e.g., iron, an iron alloy, etc.) via casting or a similar process. Additionally, the sway blocks 114 may be treated (e.g., via an austempering process) to enhance certain mechanical properties (e.g., strength, toughness, hardness, etc.). In certain embodiments, the sway blocks 114 may be manufactured without any machining. For example, each sway block may be formed from ductile iron via a casting process, and the resultant sway block may not be machined before being coupled to the sway member 116 of the three-point hitch system 14.

The sway blocks 114 include an upper sway block 118 (e.g., a second sway block) and a lower sway block 120 (e.g., a first sway block). The upper sway block 118 and the lower sway block 120 may couple to the sway member 116 via a plurality of fasteners 122 (e.g., bolts, rivets, etc.). An intermediary block 124 may separate the sway blocks 114 from the sway member 116. The intermediary block 124 may have a profile similar to the profile of the sway blocks 114. A set of sway blocks 114 may be installed on each lateral side of the sway member 116. Each set of sway blocks may include an upper sway block 118 and a lower sway block 120. While an intermediary block 124 is disposed between the sway blocks 114 and the sway member 116 in the illustrated embodiment, in other embodiments, the intermediary block may be omitted.

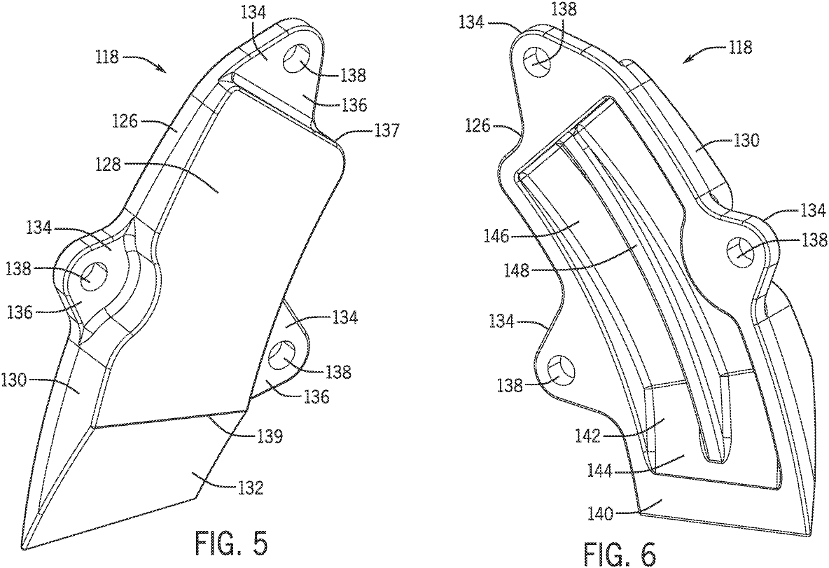

FIG. 5 is a front perspective view of the upper sway block 118 of the pair of sway blocks of FIG. 4. The upper sway block 118 includes an upper sway block body 126. A top surface 128 (e.g., a wear surface, fourth surface, etc.) of the upper sway block body 126 faces away from the sway member while the upper sway block is coupled to the sway member. The top surface 128 of the upper sway block body 126 is configured to contact the wear block during operation. In the illustrated embodiment, the top surface 128 does not contain any opening (e.g., aperture). The top surface 128 may be oriented askew of a surface of the sway member while the upper sway block is coupled to the sway member. The upper sway block body 126 includes a side surface 130 extending about the upper sway block 118 adjacent to the top surface 128. An angled surface 132 of the upper sway block body 126 extends askew of the top surface 128. The angled surface 132 is configured to overlap a corresponding angled surface of the lower sway block. In certain embodiments, the upper sway block 118 may not include the angled surface 132.

The upper sway block 118 includes one or more flange extensions 134 adjacent to the side surface 130. Each flange extension 134 includes a flange surface 136 that is offset from the top surface 128 along the lateral axis. The flange surface 136 may be offset from the top surface 128 to substantially reduce or eliminate the possibility of contact between the wear block and the respective fastener (e.g., a head of a respective bolt, etc.). Consequently, during operation, the wear block may engage the top surface 128 without affecting the fasteners. Each flange extension may include an opening 138 (e.g., an aperture) configured to receive a respective fastener to secure the upper sway block 118 to the sway member. In the illustrated embodiment, the upper sway block 118 includes three flange extensions 134. A first flange extension 134 may be located at a top edge 137 of the upper sway block 118, while a second flange extension 134 and third flange extension 134 may each be located on the lateral sides of the upper sway block 118. In other embodiments, the upper sway block 118 may have more or fewer than three flange extensions 134 in alternate locations, or no flange extensions 134. The top surface 128 is angled such that the thickness of the upper sway block body 126 increases along a direction toward an edge 139 between the top surface 128 and the angled surface 132. In other embodiments, the top surface 128 may be angled such that the thickness of the upper sway block body 126 is consistent throughout, such that the thickness decreases along the direction toward the edge 139, or the like. While the top surface of the upper sway block body does not include an opening in the illustrated embodiment, in other embodiments, the top surface of the body may have an opening configured to receive a fastener to facilitate coupling the upper sway block to the sway member.

FIG. 6 is a rear perspective view of the upper sway block 118 of FIG. 5. The upper sway block 118 has a bottom surface 140. While the upper sway block 118 is coupled to the sway member, the bottom surface 140 may rest flush against the intermediary block. The bottom surface 140 is adjacent to the side surface 130 and the angled surface 132. A cavity 142 extends from the bottom surface 140 into the upper sway block body 126. A first inner sloped surface 144 of the cavity 142 may extend substantially parallel to the angled surface 132. Additionally, a second inner sloped surface 146 of the cavity 142 may extend parallel to the top surface 128. A rib 148 may extend from the first and second inner surfaces toward the bottom surface 140. The rib 148 may have a thickness substantially equal to a thickness of the upper sway block body 126 and a thickness of the flange extensions 134. A consistent thickness may reduce warping during the casting process, eliminating a need to machine flat surfaces. The consistent thickness may also improve work hardening properties of the material.

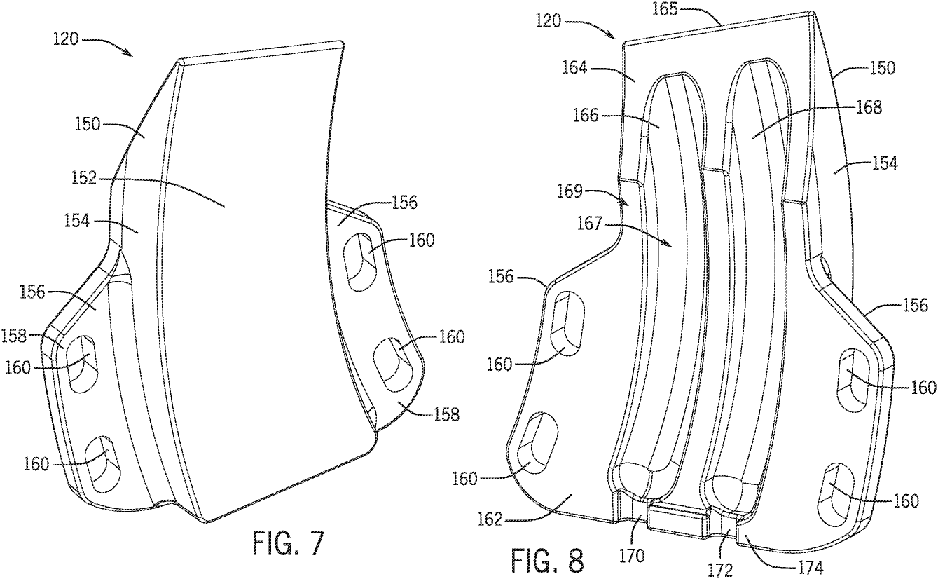

FIG. 7 is a front perspective view of the lower sway block 120 of the pair of sway blocks of FIG. 4. The lower sway block 120 includes a lower sway block body 150. A top surface 152 (e.g., wear surface, first surface, etc.) of the lower sway block body 150 faces away from the sway member while the lower sway block 120 is coupled to the sway member. The top surface 152 of the lower sway block body 150 is configured to contact the wear block during operation. In the illustrated embodiment, the top surface 152 does not contain any opening (e.g., aperture). The top surface 152 may be oriented askew of a surface of the sway member while the lower sway block is coupled to the sway member. The lower sway block body 150 includes a side surface 154 (e.g., third surface) extending about the lower sway block 120 adjacent to the top surface 152.

The lower sway block 120 includes one or more flange extensions 156 adjacent to the side surface 154. Each flange extension 156 includes a flange surface 158 that is offset from the top surface 152 along the lateral axis. Each flange extension may include one or more slots 160 (e.g., a non-circular, extended aperture) configured to receive respective fastener(s) to secure the lower sway block 120 to the sway member. Each slot 160 (e.g., first slot, second slot, third slot, fourth slot, etc.) is configured to enable the respective fastener to be positioned in multiple locations along a length of the slot 160. In certain embodiments, a user may use the slots 160 to properly align the lower sway block 120 with the respective wear block during installation. Proper alignment may improve operation and increase the longevity of the sway blocks 114 and the wear blocks 112. The slots 160 may be straight or curved. A curvature of the slots 160 may match a geometry of the lower sway block 120 or a path of travel of the wear blocks 112. The flange surface 158 of each flange extension is offset from the top surface 152 to substantially reduce or eliminate the possibility of contact between the wear block and the respective fastener (e.g., a head of a respective bolt, etc.). In the illustrated embodiment, the flange extensions 156 may be located on either side of the lower sway block 120. In other embodiments, the flange extensions 156 may be located elsewhere and there may be fewer than two flange extensions, more than two flange extensions, or none. During operation, the wear block may engage the top surface 152 without affecting the fasteners. While the top surface of the lower sway block body does not include an opening in the illustrated embodiment, in other embodiments, the top surface of the body may have an opening configured to receive a fastener to facilitate coupling the lower sway block to the sway member.

FIG. 8 is a rear perspective view of the lower sway block 120 of FIG. 7. The lower sway block 120 has a bottom surface 162 (e.g., second surface). While the lower sway block 120 is coupled to the sway member, the bottom surface 162 may rest flush against the intermediary block. The bottom surface 162 is adjacent to the side surface 154 and an angled surface 164. The angled surface 164 of the lower sway block body 150 extends askew of the bottom surface 162. The angled surface 164 is configured to overlap the angled surface of the upper sway block. The angled surface 164 is angled such that the thickness of the lower sway block body 150 decreases along a direction toward an edge 165 between the top surface 152 and the angled surface 164. In certain embodiments, the lower sway block 120 may not include the angled surface 164.

A first cavity 166 extends from the bottom surface 162 into the lower sway block body 150. A second cavity 168 also extends from the bottom surface 162 into the lower sway block body 150 adjacent to the first cavity 166. In certain embodiments, the lower sway block 120 may include more or fewer than two cavities, or no cavities at all. In other embodiments, the first cavity 166 and the second cavity 168 may be oriented in another direction. A distance 167 separating the first cavity 166 from the second cavity 168 may be the same as a wall thickness 169 of the lower sway block body 150, a thickness of the flange extensions 156, or a distance between the side surface 154 and the first cavity 166. A first outlet passage 170 extends from the side surface 154 to the first cavity 166. Additionally, a second outlet passage 172 extends from the side surface 154 to the second cavity 168. The first outlet passage 170 and the second outlet passage 172 may be located at a bottom side 174 of the lower sway block body 150. In certain embodiments, the first outlet passage 170 and the second outlet passage 172 enable passage of dust, dirt, and other type(s) of debris to flow out of the cavities. In other embodiments, each cavity may include multiple passages or no passages.

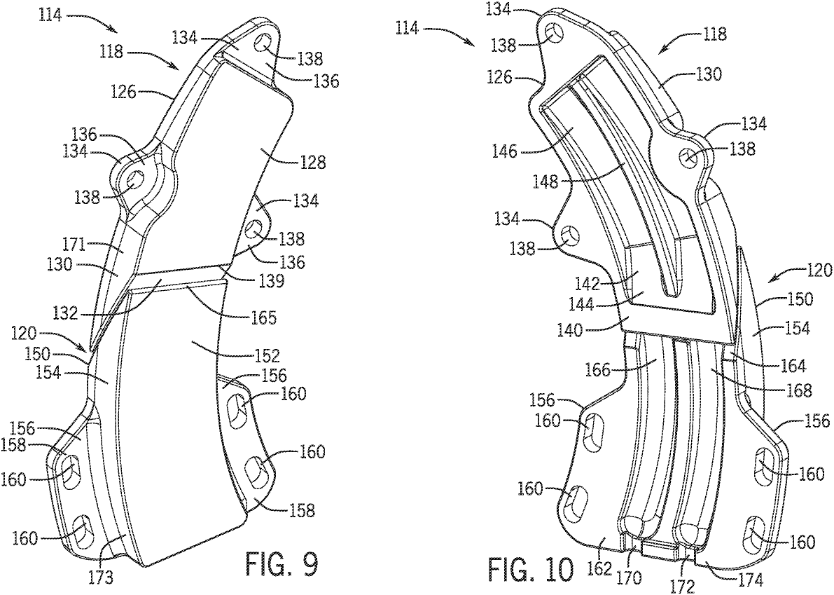

FIG. 9 is a front perspective view of the upper sway block 118 and the lower sway block 120 positioned in an installed configuration. When the sway blocks are coupled to the sway member, a portion 171 of the side surface 130 of the upper sway block 118 may substantially align with a portion 173 the side surface 154 of the lower sway block 120. As illustrated, the angled surface 132 of the upper sway block 118 overlaps the angled surface 164 of the lower sway block 120 while the sway blocks are in the illustrated installed configuration. The angled surface 132 of the upper sway block 118 may be offset from the angled surface 164 of the lower sway block 120, or the angled surface 132 of the upper sway block 118 may contact the angled surface 164 of the lower sway block 120. The upper sway block 118 may be configured to guide the wear block 112 into a configuration that allows less sway when in a lifted position. In certain embodiments, the angled surface 132 and the angled surface 156 are oriented at the same angle. In other embodiments, the angled surface 132 may overlap the angled surface 156.

FIG. 10 is a rear perspective view of the upper sway block 118 and the lower sway block 120 positioned in an installed configuration. When installed, the bottom surface 140 of the upper sway block 118 and the bottom surface 162 of the lower sway block 120 may be substantially aligned, and both bottom surfaces may lay flat against the intermediary block. In certain embodiments, the three-point hitch system may not include the lower sway block. In such embodiments, the maximum sway may be established depending on the height of the lift arms. For example, the wear block, when lowered, provides the implement hitch increased space to sway. However, when raised, the wear block may contact the angled surface 132 of the upper sway block 118 and be guided toward the top surface 128. When the wear block is aligned with the top surface of the upper sway block, the wear block/upper sway block contact may substantially block sway of the implement hitch. In certain embodiments, the flange extensions 134 of the upper sway block 118 may include slots similar to the slots 160. In other embodiments, the flange extensions 156 of the lower sway block 120 may include circular openings similar to the openings 138.

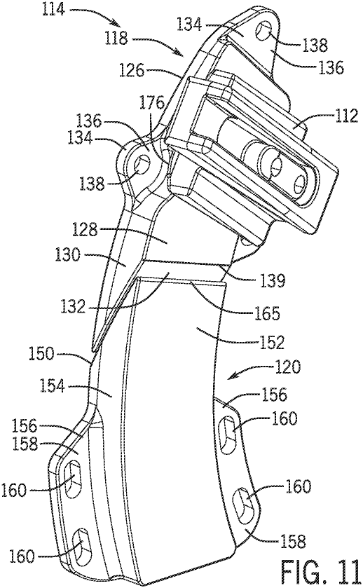

FIG. 11 is a perspective view of the upper sway block 118 and the lower sway block 120 of the sway blocks 114 positioned in an installed configuration and contacting a wear block 112 of the three-point hitch system. During operation, the wear block 112 may contact the sway blocks 114. During contact between the wear block and the upper sway block, a surface 176 of the wear block 112 may be substantially parallel to the top surface 128 of the upper sway block 118, and during contact between the wear block and the lower sway block, the surface 176 of the wear block 112 may be substantially parallel to the top surface 152 of the lower sway block 120. In certain embodiments, contact between the sway blocks 114 and the wear block may work harden the material of the sway blocks 114. The location of contact between the wear block 112 and the sway blocks 114 may vary with a height of the lower lift arms (e.g., as the lower lift arms are lifted and lowered by the actuators). For example, when lifted above a certain height threshold, the wear block 112 may contact the top surface 128 of the upper sway block 118. In another example, when lowered beneath the height threshold, the wear block 112 may contact the top surface 152 of the lower sway block 120. In certain embodiments, the upper sway block 118 may include passages similar to the outlet passages 170 and 172 extending from the side surface 130 to the cavity 142. In further embodiments, the upper sway block 118 and the lower sway block 120 may be integrally formed as one sway block.

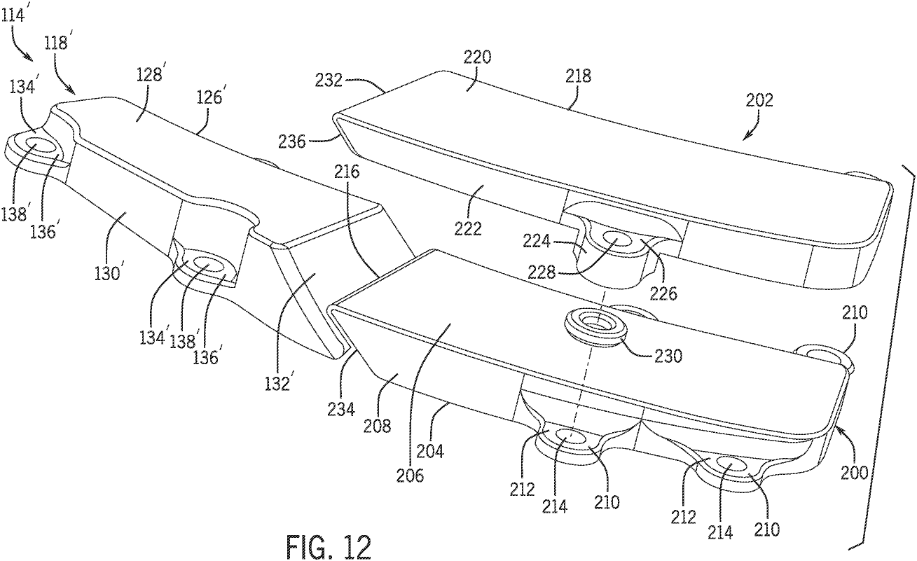

FIG. 12 is an exploded view of another embodiment of sway blocks 114' that may be employed within the three-point hitch system of FIG. 2. In the illustrated embodiment, the sway blocks 114' include a pair of lower sway blocks configured to couple to the sway member. The sway blocks 114' may be formed of metal (e.g., iron) via a casting process. The sway blocks 114' may include an upper sway block 118'. The upper sway block 118' may include any of the features and variations of the upper sway block disclosed above with reference to FIGS. 2-11, and the upper sway block 118' may be formed/treated/work-hardened via any of the techniques disclosed above with regard to the upper sway block of FIGS. 2-11. The upper sway block 118' may include an upper sway block body 116' having a top surface 128' and an angled surface 132'. A side surface 130' may extend about the upper sway block body 126' adjacent to the top surface 128' and the angled surface 132'. Additionally, the upper sway block 118' may include one or more flange extensions 134', each including a flange surface 136' and an opening (e.g., aperture) 138'. The upper sway block 118' may couple to the sway member via the openings 138' and respective fasteners. The upper sway block 118 may include a cavity similar to the cavity 142 and a rib similar to the rib 148.

The sway blocks 114' also include a first lower sway block 200 and a second lower sway block 202, each configured to contact the wear block. The first lower sway block 200 includes a first lower sway block body 204. The first lower sway block 200 also includes a top surface 206, a side surface 208 extending about the first lower sway block body 204. Additionally, the first lower sway block 200 may include one or more flange extensions 210 each including a flange surface 212 and an opening 214 (e.g., aperture). In certain embodiments, the flange extensions 210 may vary in number and be at different locations along a perimeter of the first lower sway block 200. A thickness of the first lower sway block 200 may increase in a direction toward an edge 216. In certain embodiments, the thickness of the first lower sway block 200 may be consistent across the first lower sway block body 204, or increase in the direction away from edge 216. The first lower sway block 200 may be configured to couple to the sway member via the openings 214 and the fasteners 122. The second lower sway block 202 may be configured to lay atop the first lower sway block 200 in an installed configuration. The second lower sway block 202 may include a second lower sway block body 218. Additionally, the second lower sway block 202 may include a top surface 220, and a side surface 222 extending about the second lower sway block body 218 adjacent to the top surface 220. One or more flange extensions 224 adjacent to the side surface 222 may extend past the second lower sway block body 218 toward the flange extensions 210 of the first lower sway block 200 in an installed configuration. In certain embodiments, the flange extensions 224 may vary in number and be at different locations along a perimeter of the second lower sway block 218. Each flange extensions 224 may include a flange surface 226 and an opening 228 (e.g., aperture). The second lower sway block 202 may couple to the first lower sway block 200 and the sway member 116 via the openings 228. Additionally, in certain embodiments, gasket(s) 230 may be positioned between the flange extensions 210 of the first lower sway block 200 and the flange extensions 224 of the second lower sway block 202. The gaskets 230 may be formed of metal, rubber, plastic, or another suitable material. A thickness of the second lower sway block 202 may decrease in a direction toward an edge 232. In certain embodiments, the thickness of the second lower sway block 218 may be consistent across the first lower sway block body 204, or increase in the direction away from edge 232. Each lower sway block may include an angled surface. An angled surface 234 of the first lower sway block 200 may overlap an angled surface 236 of the second lower sway block 218. In certain embodiments, a user may replace the second lower sway block 202 with a replacement sway block after it is worn down during operation. While the present discussion applies to the set of sway blocks illustrated in FIGS. 4-12, all of the discussion also applies to the symmetric set of sway blocks illustrated in FIG. 3.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]...” or “step for [perform]ing [a function]...”, it is intended that such elements are to be interpreted under 35 U.S.C. 112(f). However, for any claims containing elements designated in any other manner, it is intended that such elements are not to be interpreted under 35 U.S.C. 112(f).

1. A sway block assembly, comprising:
a sway block having a wear surface and a flange, wherein the flange comprises a first slot configured to receive a first fastener to secure the sway block to a member of a three-point hitch system, the wear surface is configured to contact a wear block of the three-point hitch system, and the wear surface is not formed on the flange.

2. The sway block assembly of claim 1, comprising a second sway block having a second wear surface and a second flange, wherein the second sway block is configured to couple to the member of the three-point hitch system via an aperture in the second flange, the second wear surface is configured to contact the wear block of the three-point hitch system, the second wear surface is not formed on the second flange, and the second wear surface does not comprise an aperture.

3. The sway block assembly of claim 2, wherein the second flange comprises a second slot configured to receive a second fastener to secure the second sway block to the member of the three-point hitch system.

4. The sway block assembly of claim 3, wherein the second sway block comprises a third flange having a third slot and a fourth slot, the third slot is configured to receive a third fastener to secure the second sway block to the member of the three-point hitch system, and the fourth slot is configured to receive a fourth fastener to secure the second sway block to the member of the three-point hitch system.

5. The sway block assembly of claim 1, comprising:
a second sway block having a second wear surface and a second flange, wherein the second sway block is configured to couple to the member of the three-point hitch system via an aperture in the second flange, the second wear surface is configured to contact a second wear block of the three-point hitch system, and the second wear surface is not formed on the second flange; and
a third sway block having a third wear surface and a third flange, wherein the third flange comprises a third slot configured to receive a third fastener to secure the third sway block to the member of the three-point hitch system, and the third wear surface is configured to contact the second wear block of the three-point hitch system, and the third wear surface is not formed on the third flange.

6. The sway block assembly of claim 5, wherein the second sway block is symmetrical with the sway block about a vertical axis of the three-point hitch system.

7. The sway block assembly of claim 1, wherein the sway block is formed of iron via a casting process.

8. The sway block assembly of claim 7, wherein the sway block is treated via an austempering process.

9. The sway block assembly of claim 8, wherein the sway block is configured to work-harden during contact with the wear block.

10. The sway block assembly of claim 2, wherein the first slot comprises a curved slot.

11. A sway block assembly for a three-point hitch system of an agricultural system, comprising a sway block, wherein the sway block comprises:
a first surface configured to contact a wear block of the three-point hitch system;
a second surface configured to abut a member of the three-point hitch system;
a third surface extending about a periphery of the sway block;
a cavity extending into the sway block from the second surface; and
an outlet passage extending from the third surface to the cavity.

12. The sway block assembly of claim 11, comprising a second sway block, wherein the second sway block comprises a fourth surface configured to contact the wear block of the three-point hitch system.

13. The sway block assembly of claim 11, wherein the sway block comprises:
a second cavity adjacent to the cavity and extending into the sway block from the second surface; and
a second outlet passage extending from the third surface to the second cavity.

14. The sway block assembly of claim 13, wherein a distance between the first cavity and the second cavity is the same as a distance between the third surface and the first cavity.

15. The sway block assembly of claim 11, wherein the outlet passage is configured to enable passage of debris from the cavity.

16. A sway block assembly, comprising:
a three-point hitch system configured to couple an agricultural implement to a work vehicle, comprising:
a wear block;
a sway member; and
a sway block having a wear surface and a flange comprising an aperture, wherein the wear surface is configured to contact the wear block, wherein the sway block is configured to couple to the sway member via the aperture, the wear surface is not formed on the flange, and the wear surface does not comprise an aperture.

17. The sway block assembly of claim 16, comprising a second sway block having a second wear surface and a second flange comprising a second aperture, wherein the second wear surface is configured to contact the wear block, wherein the second sway block is configured to couple to the sway member via the second aperture, the second wear surface is not formed on the second flange, and the second wear surface does not comprise an aperture.

18. The sway block assembly of claim 17, wherein the sway block comprises a first angled surface adjacent to the wear surface.

19. The sway block assembly of claim 18, wherein the second sway block comprises a second angled surface adjacent to the second wear surface.

20. The sway block assembly of claim 19, wherein the first angled surface is configured to be spaced from the second angled surface in an installed configuration, the first angled surface and second angled surface are oriented at the same angle, and the first angled surface overlaps the second angled surface.
